(19) United States
(12) Patent Application Publication
(10) Pub. No.: US 2008/0260318 A1
(43) Pub. Date: Oct. 23, 2008

(54) ROLLER BEARING WITH A BRAKING DEVICE

(75) Inventors: Jorg Schuh, Emskirchen (DE); Jurgen Stolzle, Erlangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 12/105,330

(22) Filed: Apr. 18, 2008

(30) Foreign Application Priority Data
Apr. 18, 2007 (DE) 102007018158.4

(51) Int. Cl. F16C 19/22

(52) U.S. Cl. 384/618

(57) ABSTRACT

A roller bearing (1) with a braking device, in particular, rotating connection, made from a bearing outer ring (2) and a bearing inner ring (3), between which there are provided roller bodies roll on associated raceways. For achieving a braking effect by a friction-fit connection, a movable brake element connected to one of the bearing rings (2, 3) is pressed against a counter surface of the other bearing ring (3, 2) and the force releasing the friction-fit connection can be applied by hydraulic medium. The friction-fit connection is generated according to the principles of the governing hydrostatic equation, wherein a brake lining (18) is surrounded by a hydraulic pressure medium (19) that is connected to a deflection space (21), which can be added on and in which a movable pressure piston (15) is arranged, wherein this piston can change the volume of this deflection space.

### CROSS-REFERENCE TO RELATED APPLICATIONS

This application claims the benefit of DE 102007018158.4, filed Apr. 18, 2007, which is incorporated herein by reference as if fully set forth.

### BACKGROUND

The invention relates to a roller bearing with a braking device, in particular, a rotating connection, made from a bearing outer ring and a bearing inner ring, between which roller bodies roll on associated raceways, wherein, for achieving a braking effect through a friction-fit connection, a movable brake element connected to one of the bearing rings is pressed against a counter surface of the other bearing ring and the force releasing the friction-fit connection can be applied by hydraulic medium.

A bearing arrangement according to the class with a braking function is known from DE 199 17 498 A1. As can be taken from FIGS. 1 and 2 and the associated description, the roller bearing rotating connection is formed from an inner ring and an outer ring, which are rotatably connected via balls so that they can rotate relative to each other. The outer ring has teeth, which engage the not-shown pinion of the rotating drive. The bearing rings are screwed to the connection constructions by attachment boreholes. The bearing gap is located between the bearing rings. In the embodiment according to FIGS. 1 and 2, the cylinder boreholes distributed on the outside as a circle of holes are supplied with pressurized oil via a feed line. The pistons, which close the cylinder boreholes by using conventional hydraulic seals, press against the braking surface of the outer ring and the braking surface of the additional ring screwed to the outer ring and the connection construction. The hydraulic normal force that can be regulated by the pressure on the radial, overlapping braking surfaces of the pistons and rings produces increased friction, wherein a controllable braking moment acting in the opposite sense counteracts rotational movements or, for a corresponding high braking moment, reduces rotational movements with a friction-fit connection.

Here it is disadvantageous that a hydraulic braking device constructed in this way is very complicated. First, in the bearing inner ring a plurality of boreholes spaced uniformly from each other must be drilled, in which corresponding pistons are then inserted. Second, the boreholes or the pistons must be sealed in a very complex way, so that no hydraulic medium can leak out. Leaking hydraulic mediem represent a great risk in special applications, for example, in medical technology.

Another bearing arrangement according to the class with a braking device is known from DE 10 2004 052 598 A1. As FIGS. 1 and 2 show, the braking system includes braking surface means, which have a surrounding, ring-like shape and which are arranged in a corresponding groove of the casing of the first roller bearing ring. In at least one position on the casing of the second roller bearing ring opposite the braking surface means, braking means that can be actuated are arranged in a corresponding, radial borehole in the roller bearing ring. Here the borehole for the braking means is advantageously arranged between two boreholes of the second roller bearing ring. The braking means that can be actuated include a piston that can be moved hydraulically within this borehole, wherein the piston is provided on its end side facing the braking surface means with an exchangeable brake shoe. Therefore, because the brake shoe is connected in an exchangeable way, i.e., in particular, detachably to the piston, when necessary, it can be renewed as a single wearing part of the roller bearing arrangement. On the side facing away from the braking surface means, the borehole is closed by a hydraulic connection, by which hydraulic fluid can be pressed into the borehole for corresponding movement of the piston between the hydraulic connection and the piston. Here, there is also the risk that hydraulic fluid can leak out due to defective seals.

### SUMMARY

Starting with the disadvantages of the known state of the art, the invention is based on the objective of providing a braking device that can be activated hydraulically for a roller bearing and that, in particular, can be produced easily and that has a high braking effect.

According to the invention, this objective is met in that the friction-fit connection is generated according to principles of the governing hydrostatic equation, wherein a brake lining is surrounded by a hydraulic pressure medium, which is connected to a deflection space that can be added on. A movable pressure piston that changes the volume of the deflection space is arranged in this space.

As someone skilled in the art knows, hydraulic systems take advantage of the independence of the pressure from the vessel shape. For example, if hydraulic medium is pressed through a pipe with a relatively small cross section A1 into a vessel with a large cross section A₂, then the pressure p in the pipe is equal to the pressure in the vessel. The force to be applied in the pipe is F₁=p A₁. The force in the vessel, however, acts on the entire cross-sectional surface area; therefore it is F₂=p A₂ and is greater by a multiple. The hydraulic system acts as a force amplifier. In this way it is possible to generate a large braking force with a small controllable force. In addition to the amplified braking force, the advantage of this brake arrangement according to the invention lies particularly in that no hydraulic medium has to be supplied from the outside and thus complicated seals for preventing leakage are not needed.

Other advantageous constructions of the invention are described below.

For example, in one aspect of the invention it is provided that the hydraulic pressure medium is held by a flexible and impermeable sleeve. As already stated, it is guaranteed that from the outside no hydraulic pressure medium has to be inserted into the system, because this is always available within the system.

According to another additional feature of the invention, the sleeve should be in active connection with an adjustment element at several positions set apart from each other uniformly in the peripheral direction. These have the task of providing the hydraulic medium in the sleeve with a corresponding working pressure, i.e., with a corresponding braking pressure.

According to another additional feature of the invention, the pressure piston should be connected to an activation piston, which can be moved electromagnetically or pneumatically. This activation piston ensures that the deflection space, which is important for the braking force, is variable in its volume via the pressure piston.

According to another aspect of the invention, the activation piston can be moved against the force of a spring element. In this way it is guaranteed that even for a loss of power, which would prevent displacement of the activation piston, the roller bearing is still braked.

Additionally, according to another aspect of the invention, the activation piston is also to be connected to an engaging fork, whose sides each receive a force from a spring element, wherein the engaging fork is connected to a trip lever, which is, in turn, in active connection with the pressure piston. Through a different construction of the trip lever, the braking force can be influenced again by the lever ratios.

According to another additional feature of the invention, it is provided that the roller bodies are formed by bearing needles of two axial inclined needle bearings, wherein an intersection point of its extended rotational axis lies in the bearing inner ring or in the bearing outer ring. Compared with known rotating connections, which are preferably constructed as four-point bearings or as cross roller bearings, production is significantly more economical for the use of axial inclined needle bearings at the same or higher load ratings. In connection with this, it has proven advantageous according to the invention that the axial inclined needle bearings are set in an O-arrangement relative to each other and have washer disks carrying the raceways. These can be subjected to a hardening process according to another feature of the invention, wherein it has proven advantageous according to the invention that washer disks and at least one of the bearing rings are made from different materials, so that the weight of the entire bearing arrangement can be reduced. The bearing ring or rings can be made from a plastic or from a lightweight metal.

According to another feature of the invention, one of the bearing rings has a two-part construction for adjusting the bias, wherein this is connected to a lock nut that can move in the axial direction. Here it has proven advantageous according to another feature of the invention when the lock nut is held by a thread of a corresponding counter thread of the bearing ring.

Finally, according to another feature of the invention, the roller bearing can be used in a ceiling stand for medical devices. Such ceiling stands have been known for a long time and are described in detail, for example, in DE 36 27 517 A1, DE 43 06 803 A1, and DE 199 63 512 C1.

### BRIEF DESCRIPTION OF THE DRAWINGS

Additional features of the invention emerge from the following description and from the drawings, in which a preferred embodiment of the invention is shown in simplified form.

Shown are:

FIG. 1 is a perspective view of a roller bearing with a braking device according to the invention,

FIG. 2 is an axial section view through the roller bearing according to FIG. 1 in the region of the braking device,

FIG. 2a is an enlarged detail view in the region of the braking device according to FIG. 2,

FIG. 3 is a radial section view through the roller bearing according to FIG. 1, and

FIGS. 4 and 5 are each an enlarged views in a region of the braking device according to FIG. 3 in a non-braked and braked state.

### DETAILED DESCRIPTION OF THE PREFERRED EMBODIMENTS

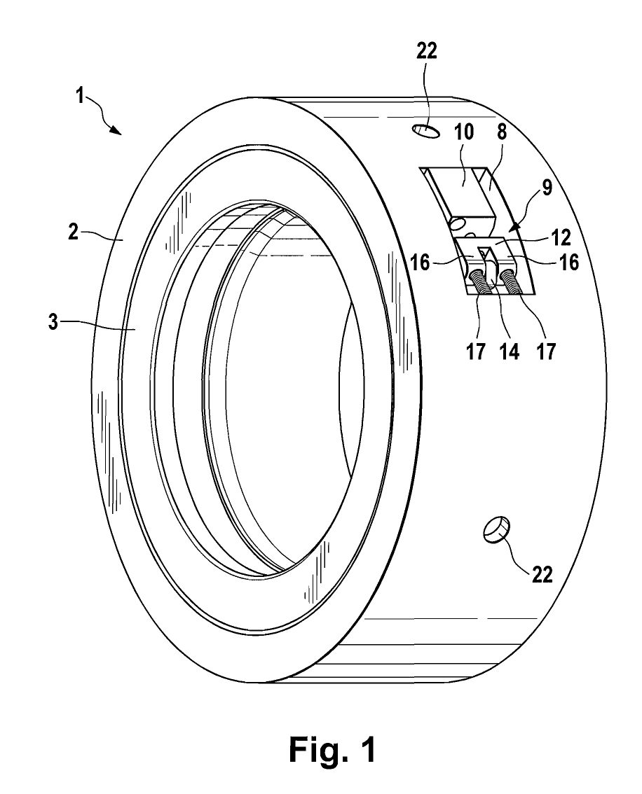

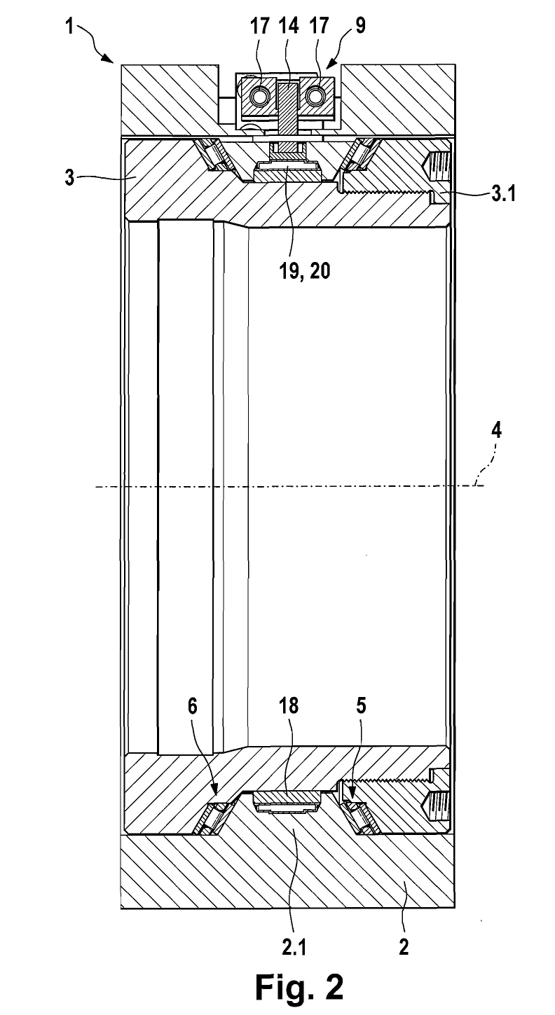

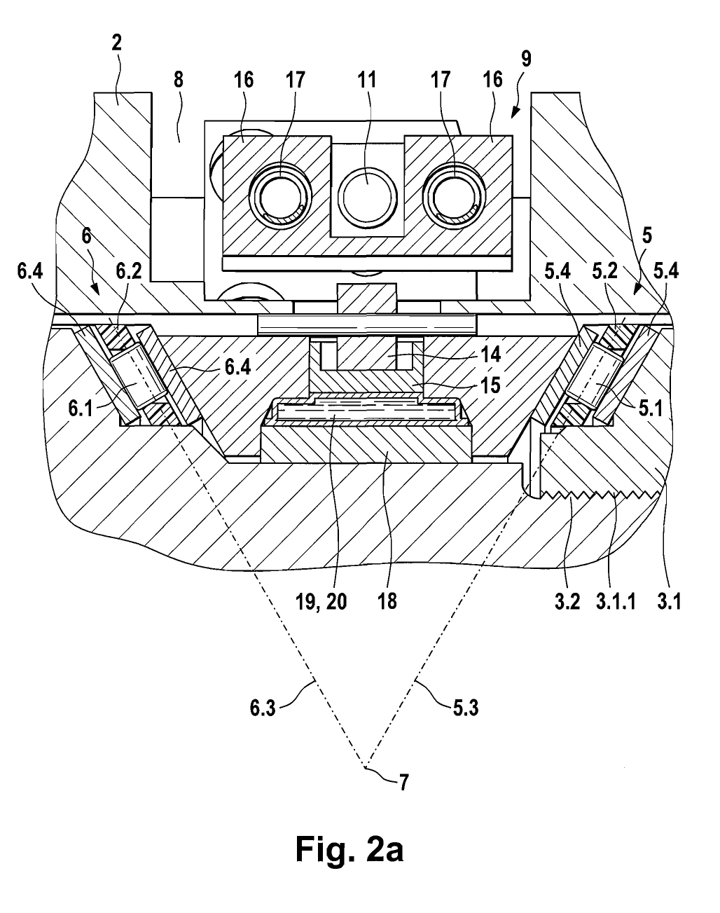

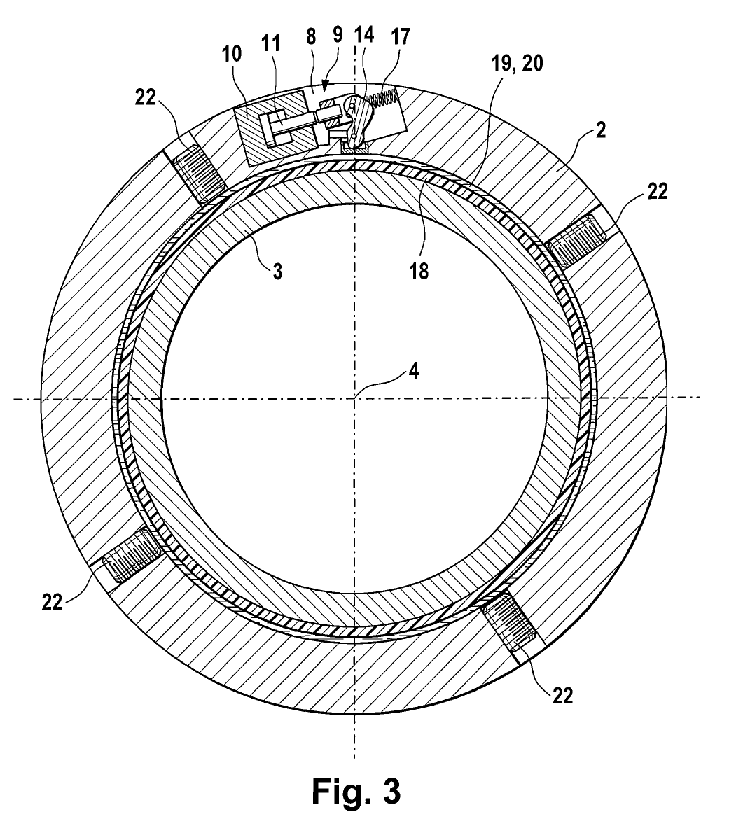

The roller bearing 1 constructed according to the invention and shown in FIGS. 1 to 3 is made from the bearing outer ring 2 and the bearing inner ring 3, which are arranged one inside the other concentrically around the bearing axis 4. In the annular space formed between the two rings, there are axial inclined needle bearings 5, 6, which are set in an O-arrangement relative to each other. Both include roller bodies in the form of bearing needles 5.1, 6.1, which are each guided in a cage 5.2, 6.2, wherein the extended rotational axes 5.3, 6.3 of the bearing needles 5.1, 6.2 intersect at point 7, which lies in the bearing inner ring 3. Two washer disks 5.4, 6.4 support the axial inclined needle bearings 5, 6, respectively, which provide the raceways not shown in more detail for the bearing needles 5.1, 6.1. In particular, from FIG. 2a it can be seen that the slope angle α can be variable and thus the ratio of radial and axial force application can be influenced. As is also visible, the bearing inner ring 3 has a two-part construction, wherein the lock nut 3.1 is screwed with its internal thread 3.1.1 on the external thread 3.2 of the bearing inner ring 3 and thus can be displaced in the axial direction. In this way, the bearing bias can be adjusted in a simple way by tightening the lock nut 3.1, wherein the two axial inclined needle bearings 5, 6 are pressed against the V-shaped projection 2.1 of the bearing outer ring 2.

Another advantage of this bearing arrangement is given by the separation of the washer disks 5.4, 6.4 providing the raceways and the actual bearing rings 2, 3. Thus, it is possible to make the bearing rings 2, 3 from a non-iron material, for example, from a plastic or a lightweight metal, so that the weight of the entire arrangement can be reduced.

As can be further seen from the figures, in a recess 8 of the bearing outer ring 2, there is a moving brake element 9, which is shown, in particular, by the enlarged diagrams in FIGS. 2a, 4, and 5 and which is constructed as follows:

The activation piston 11, which can be moved pneumatically or electromagnetically, is held in the housing 10 arranged in the recess 8. This activation piston 11 is connected to a fork-shaped part designated below as an engaging fork 12. The engaging fork 12 is connected on one side to the trip lever 14 via the bolt 13 in its central recess (not shown in more detail). This trip lever 14 is in active connection with the pressure piston 15, in turn, by another bolt 13 fixed in the bearing outer ring 2. On the other side, the two side walls 16 of the trip lever 14 are supported by spring elements 17, which contact an end wall of the recess 8.

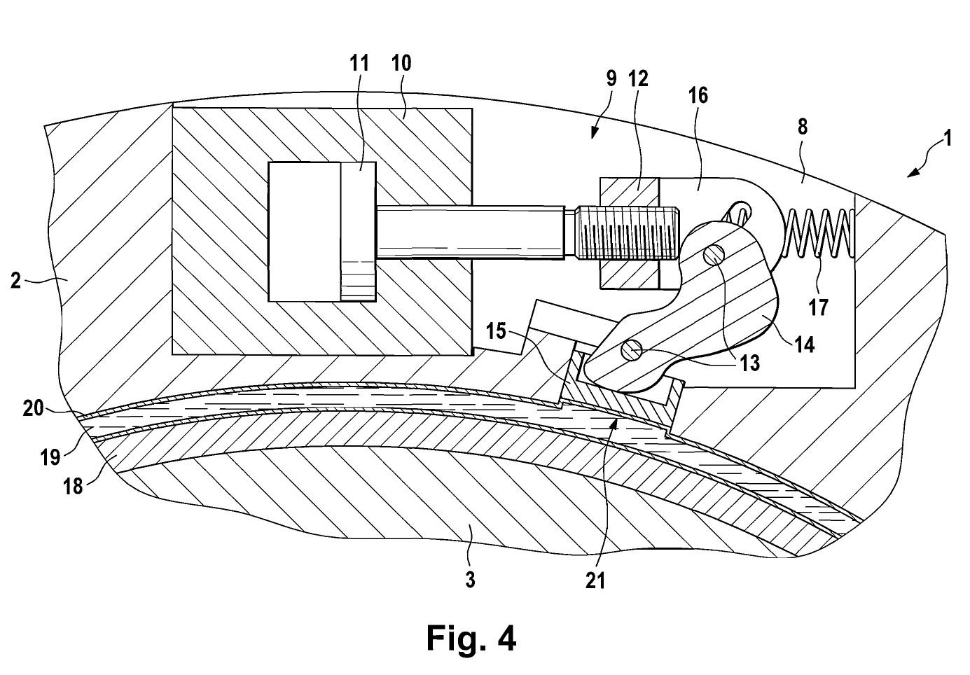

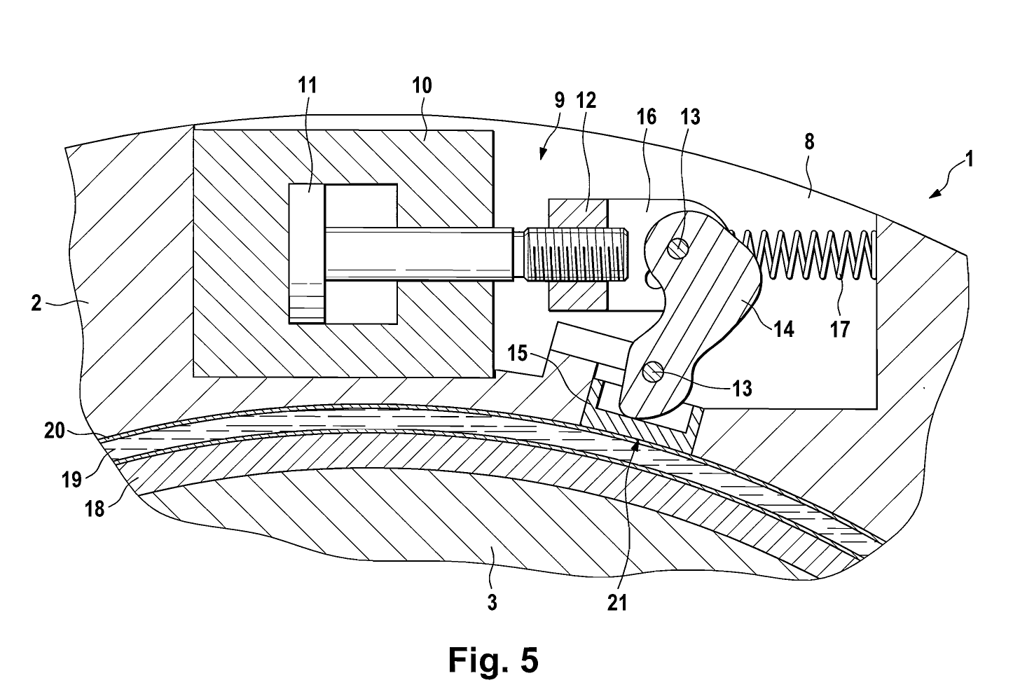

As can be seen, in particular, from the enlarged diagrams of FIGS. 2a, 4, and 5, the brake lining 18, which is surrounded, in turn, by the hydraulic pressure medium 19 held in the flexible and impermeable sleeve 20, is arranged between the bearing inner ring 3 and the bearing outer ring 2. Here, as can be seen from FIG. 1, adjustment elements 22 set apart from each other uniformly in the peripheral direction in the bearing outer ring 2 can influence the hydraulic pressure medium 19. With reference to FIGS. 4 and 5, now the relationship between the hydraulic pressure medium 19 on one side and the deflection space 21 on the other side, in which the pressure piston 15 is guided, will be explained in more detail:

In the embodiment according to FIG. 4, the non-braked state of the roller bearing 1 is shown, wherein the bearing outer ring 2 is locked in rotation with a not-shown connection construction and the bearing inner ring 3 can rotate about the bearing axis 4. As shown, the activation piston 11 receives a force pneumatically or electromagnetically, so that it contacts the housing 10 on the right side. Through the action of the activation piston 11, the engaging fork 12, the trip lever 14, and the pressure piston 15, the deflection space 21, which has a cylindrical shape, is variable in its volume, wherein the pressure piston 15 can be moved in the radial direction. This deflection space 21 is bounded, on one side, by the circular base surface of the pressure piston 15 and is open in the other direction. This deflection space 21 is connected to the hydraulic pressure medium 19, which, as already described, is held in a leakage-tight way by the sleeve 20. In the non-braked state, the pressure piston 15 receives a force acting in the radial direction, so that the hydraulic pressure medium 19 can deflect into the free space 21. This has the consequence that a force acting inwardly in the radial direction is not exerted on the friction lining 18, so that the bearing inner ring 3 is not braked. As can be seen, in the non-braked state, the effect of the spring 17 is neutralized by the right-side contact of the activation piston 11.

In FIG. 5, the brake element 9 is shown as it functions, i.e., the rotating bearing inner ring 3 is applied with a friction moment by the brake lining 18. In this case, no force is exerted on the activation piston 11, so that this piston is brought into contact with the left end side of the housing 10 by the spring element 17 acting on the side walls 16 of the engaging fork 14. This has the consequence that the trip lever 14 locked in the bolt 13 changes its position due to the effect of the spring element 17 and moves the pressure piston 15 inward in the radial direction, so that the deflection space 21 is reduced in volume until it finally assumes the value of zero. The deflection space 21 is defined accordingly by the displacement path of the pressure piston 15, which assumes its greatest value in a first stop position according to FIG. 4 and which assumes the value of zero in a second stop position according to FIG. 5. With respect to the governing hydrostatic equation, this means that with a small force F₁ to be applied, which is to be allocated to the circular surface area A₁ of the pressure piston 15, a braking force F₂ that is greater by a multiple is generated, which is to be allocated to the casing surface area A₂ of the sleeve 20 with enclosed hydraulic pressure medium 19. Because the surface area A₂ is significantly larger than the surface area A₁, according to the formula

$${F}_{2} = \frac{{F}_{1}}{{A}_{1}} \cdot {A}_{2}$$

the force F₂ is significantly greater than the force F₁. The hydraulic system acts as a force amplifier, wherein the ratio of F₁ to F₂ can move in the range from 1 to 1000.

With respect to the arrangement of the brake element 9 in the stationary bearing outer ring 2, at this point it should be noted again that it involves merely schematic diagrams for illustrating the principle setup of the invention. The brake element 9 could be applied similarly as a component of the inner ring 3. For each concrete application, the individual bearing components, including the braking device, are to be designed in detail in terms of construction and material selection.

### REFERENCE SYMBOLS

1 Roller bearing
2 Bearing outer ring
2.1 Projection
3 Bearing inner ring
3.1 Lock nut
3.1.1 Internal thread
3.2 External thread
4 Bearing axis
5 Axial inclined needle bearing
5.1 Bearing needle
5.2 Cage
5.3 Rotational axis
5.4 Washer disk
6 Axial inclined needle bearing
6.1 Bearing needle
6.2 Cage
6.3 Rotational axis
6.4 Washer disk
7 Point
8 Recess
9 Brake element
10 Housing
11 Activation element
12 Engaging fork
13 Bolt
14 Trip lever
15 Pressure piston
16 Side wall
17 Spring element
18 Brake lining
19 Hydraulic pressure medium
20 Sleeve
21 Deflection space
22 Adjustment element
α Slope angle

1. Roller bearing with a braking device, comprising a bearing outer ring and a bearing inner ring, between which roller bodies roll on associated raceways, wherein, for achieving a braking effect by a friction-fit connection, a movable brake element is connected to one of the bearing rings and is movable against a counter surface of the other bearing ring and a force releasing the friction-fit connection can be applied by hydraulic medium, the friction-fit connection is generated by hydrostatic action, wherein a brake lining is surrounded by a hydraulic pressure medium that is connected to a deflection space, which can be added on and in which a movable pressure piston is arranged, wherein the piston can change a volume of the deflection space.

2. Roller bearing according to claim 1, wherein the hydraulic pressure medium is received by a flexible and impermeable sleeve.

3. Roller bearing according to claim 2, wherein the sleeve is in active connection with an adjustment element at several points set apart from each other uniformly in a peripheral direction.

4. Roller bearing according to claim 3, wherein the pressure piston is connected to an activation piston, which can be moved electromagnetically or pneumatically.

5. Roller bearing according to claim 4, wherein the activation piston can be moved against a force of a spring element.

6. Roller bearing according to claim 4, wherein the activation piston is connected to an engaging fork having side walls that each receive a force from a spring element, wherein the engaging fork is connected to a trip lever, which is in active connection, in turn, with the pressure piston.

7. Roller bearing according to claim 1, wherein the roller bodies are formed by bearing needles of two axial inclined needle bearings that are inclined in opposite directions, and an intersection point of extended rotational axes of the needle bearings lies in the bearing inner ring or in the bearing outer ring.

8. Roller bearing according to claim 7, wherein the axial inclined needle bearings are set in an O-arrangement relative to each other and have washer disks forming raceways.

9. Roller bearing according to claim 8, wherein the washer disks are subjected to a hardening process.

10. Roller bearing according to claim 9, wherein the washer disks and at least one of the bearing rings are made from different materials.

11. Roller bearing according to claim 7, wherein one of the bearing rings has a two-part construction for adjusting bias, and the one of the bearing rings is connected to a lock nut adjustable in the axial direction.

12. Roller bearing according to claim 11, wherein the lock nut is held by a thread in a corresponding counter thread of the one of the bearing rings.

13. Roller bearing according to claim 1, wherein the bearing is in a ceiling stand for medical devices.
